(19) United States
(12) Patent Application Publication
(10) Pub. No.: US 2018/0322133 A1
(43) Pub. Date: Nov. 8, 2018

(54) SYSTEMS AND METHODS FOR AUTOMATED CONTENT POST PROPAGATION

(71) Applicant: Facebook, Inc., Menlo Park, CA (US)

(72) Inventors: Zhonghu Gao, Fremont, CA (US); Hong Guo, Foster City, CA (US)

(21) Appl. No.: 15/584,980

(22) Filed: May 2, 2017

(51) Int. Cl. G06F 17/30; H04L 29/08; H04L 12/58; G06F 17/22; G06F 17/24

(52) U.S. Cl. CPC G06F 17/3089; H04L 67/02; G06F 17/24; G06F 17/30905; G06F 17/2247; H04L 51/16

(57) ABSTRACT

Systems, methods, and non-transitory computer-readable media can identify a page cluster comprising a source page and a destination page. A content post posted to the source page is received. The content post is automatically propagated to the destination page.

### FIELD OF THE INVENTION

The present technology relates to the field of content sharing. More particularly, the present technology relates to systems and methods for automated propagation of content posts between accounts on a social networking system.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

### SUMMARY

Various embodiments of the present disclosure can include systems, methods, and non-transitory computer readable media configured to identify a page cluster comprising a source page and a destination page. A content post posted to the source page is received. The content post is automatically propagated to the destination page.

In an embodiment, the page cluster comprises a parent page and a plurality of child pages, the source page is the parent page, and the destination page is a child page of the plurality of child pages.

In an embodiment, the parent page is associated with a brand, and the child page is associated with a brick-and-mortar location of the brand.

In an embodiment, it is determined that the content post is to be propagated based on source page propagation criteria.

In an embodiment, the source page propagation criteria comprises a propagation setting selected by an administrator of the source page.

In an embodiment, the propagation setting comprises at least one of: a selection to always propagate content posts, a selection to propagate content posts to destination pages that have never posted their own content posts, or a selection to propagate content posts to destination posts that have not posted their own content posts within a threshold period of time.

In an embodiment, it is determined that the destination page has not opted out of content post propagation.

In an embodiment, the automatically propagating the content post to the destination page is performed based on the determining that the destination page has not opted out of content post propagation.

In an embodiment, the automatically propagating the content post to the destination page causes the content post to be posted to the destination page, and the content post is posted to the destination page with a page name that is associated with the source page.

In an embodiment, the page cluster comprises a plurality of destination pages, and the automatically propagating the content post to the destination page further comprises automatically propagating the content post to the plurality of destination pages.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an automated content propagation module, according to an embodiment of the present disclosure.

FIG. 2 illustrates an example content propagation module, according to various embodiments of the present disclosure.

FIG. 3A illustrates an example user interface including an example source page, according to various embodiments of the present disclosure.

FIG. 3B illustrates an example user interface including an example destination page, according to various embodiments of the present disclosure.

FIG. 4 illustrates an example method associated with automated content post propagation, according to an embodiment of the present disclosure.

FIG. 5 illustrates an example method associated with automated content post propagation, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Automated Content Post Propagation

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

An administrator of a page on a social networking system can be provided with the ability to post content posts on the page. When new and interesting content posts are regularly posted to a social networking system, users are incentivized to continue visiting and utilizing the social networking system. As such, it remains an important interest for a social networking system to encourage and facilitate new content posts by users. However, under conventional approaches, many pages on a social networking system may lie dormant with little to no content post activity by those pages.

For example, under conventional approaches, a parent page on a social networking system may be associated with a particular brand, and child pages may be associated with individual brick-and-mortar locations associated with the brand. In one instance, the parent page may be associated with a nationwide coffee shop chain, and each child page may be associated with a particular store location of the coffee shop chain. While the parent page associated with the brand may be very active on the social networking system and may be updated frequently with new content posts, certain of the individual child pages may not be as active on the social networking system. Furthermore, under conventional approaches, it may be impractical for an administrator of the parent page to generate dedicated content posts specifically for the various child pages. This may be the case, for example, for a nationwide brand that may have hundreds or thousands of locations, and, therefore, hundreds or thousands of child pages.

As such, conventional approaches may result in pages that have very few or no content posts. As just one example, if a user on the social networking system happens to visit and/or follow an inactive child page (e.g., a page associated with a coffee shop location near the user), the consumer user may assume that the brand is not active on the social networking system based on the child page's lack of activity. In this example, the parent page may lose an important opportunity to engage with a user, and the social networking system may also lose an important opportunity to present interesting content to the user. This can be particularly problematic in some instance because many individual users may be more likely to visit pages associated with specific locations of a brand (i.e., child pages) rather than visiting a page associated with the brand itself (i.e., a parent page). Accordingly, conventional approaches may not be effective in addressing these and other problems arising in computer technology.

An improved approach rooted in computer technology overcomes the foregoing and other disadvantages associated with conventional approaches specifically arising in the realm of computer technology. In general, a page cluster comprising a plurality of pages, such as pages of a social networking system, can be identified. The page cluster can comprise a plurality of pages that are related to one another in one way or another. The page cluster can comprise one or more source pages from which content posts can be sourced, and one or more destination pages to which content posts can be propagated. A content post can be posted to a source page. A determination can be made as to whether to propagate the content post based on source page propagation criteria. The content post can be propagated to at least one of the one or more destination pages based on destination page selection criteria. When a content post is propagated from a source page to a destination page, the content post can be presented on the destination page. As such, when other users visit the destination page, rather than being presented with a page having few or no content posts, one or more propagated content posts can be presented. More details regarding the present disclosure are provided herein.

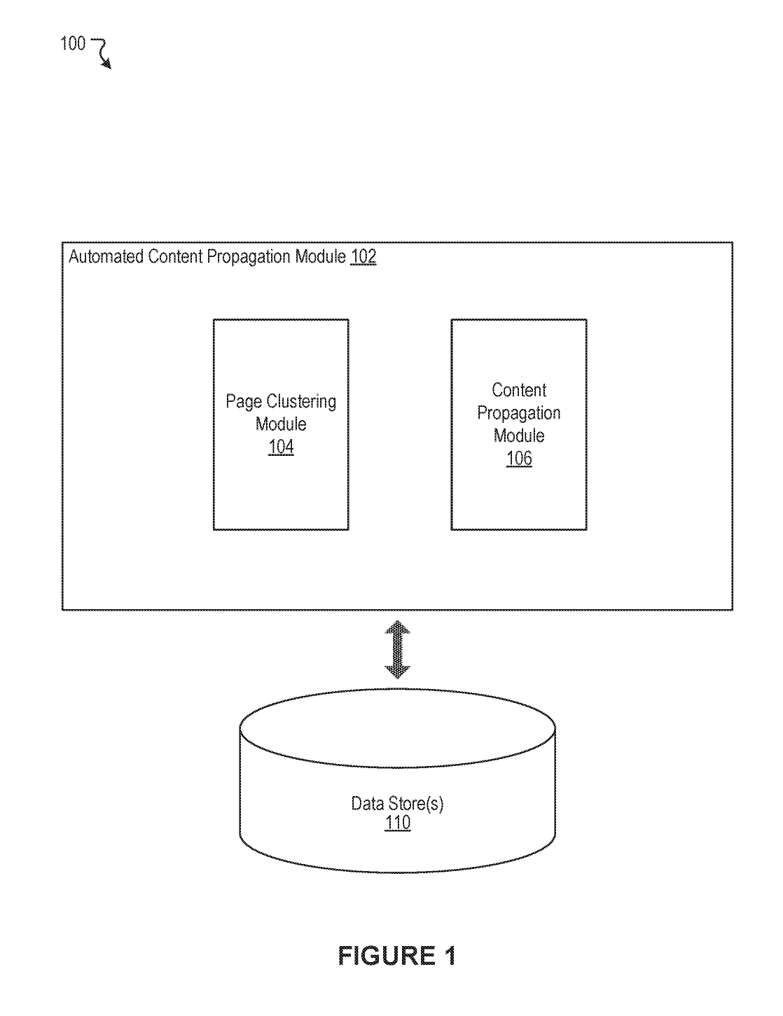

FIG. 1 illustrates an example system 100 including an example automated content propagation module 102, according to an embodiment of the present disclosure. The automated content propagation module 102 can be configured to automatically propagate a content post from a first page to a second page. In some embodiments, the first page and the second page can be pages on a social networking system. When a content post is propagated from a first page to a second page, the content post that was originally posted to the first page also can be posted to the second page. In various embodiments, the automated content propagation module 102 can be configured to identify a page cluster comprising a plurality of pages. The pages in a page cluster can be grouped together based on page association information. For example, the page association information may indicate a parent-child association between a plurality of pages. The page cluster can comprise at least one source page from which content posts can be sourced, and at least one destination page to which content posts can be propagated. For example, a parent page may be a source page, and a child page may be a destination page such that a content post posted to the parent page can be propagated to the child page. The automated content propagation module 102 can be configured to receive a content post posted to a source page. A determination can be made as to whether or not to propagate the content post to one or more destination pages based on source page propagation criteria. For example, source page propagation criteria may comprise a source page propagation setting selected by an administrator of the source page. The automated content propagation module 102 can identify a destination page based on destination page selection criteria. For example, the destination page selection criteria can comprise a destination page propagation setting selected by an administrator of the destination page. The automated content propagation module 102 can automatically propagate the content post from the source page to the destination page, such that the content post, initially posted to the source page, is also posted to the destination page.

As shown in the example of FIG. 1, the automated content propagation module 102 can include a page clustering module 104 and a content propagation module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the automated content propagation module 102 can be implemented in any suitable combinations.

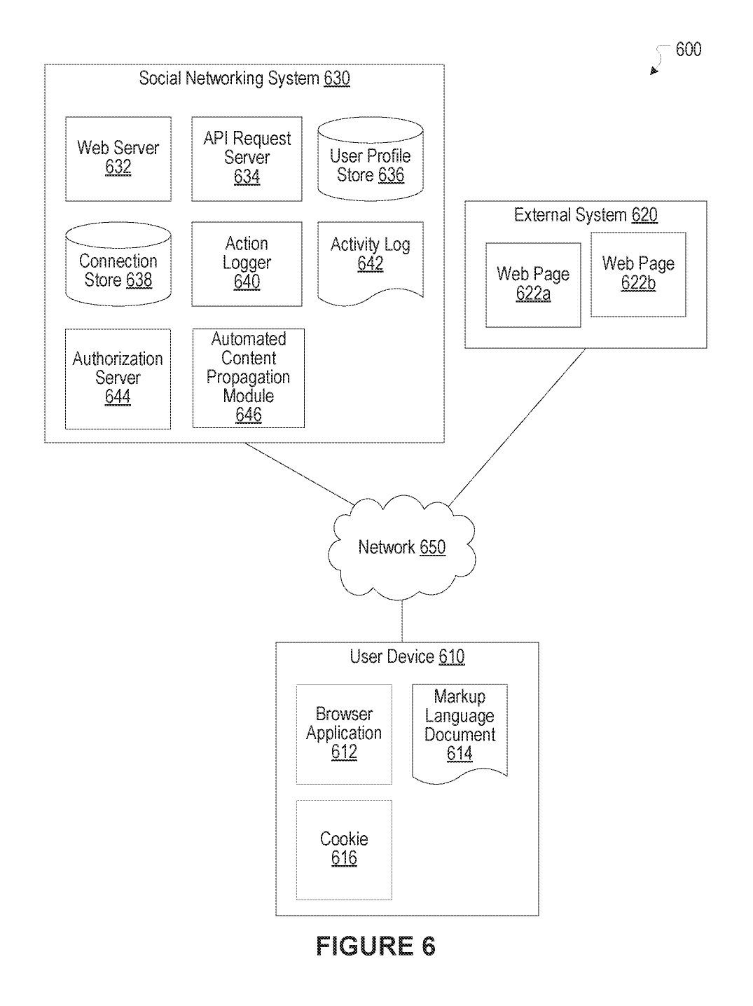

In some embodiments, the automated content propagation module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the automated content propagation module 102 can be implemented, in part or in whole, as software running on one or more computing devices or systems, such as on a user or client computing device. For example, the automated content propagation module 102, or at least a portion thereof, can be implemented as or within an application (e.g., app), a program, or an applet, etc., running on a user computing device or a client computing system, such as the user device 610 of FIG. 6. In another example, the automated content propagation module 102, or at least a portion thereof, can be implemented using one or more computing devices or systems that include one or more servers, such as network servers or cloud servers. In some instances, the automated content propagation module 102 can, in part or in whole, be implemented within or configured to operate in conjunction with a social networking system (or service), such as the social networking system 630 of FIG. 6. It should be understood that there can be many variations or other possibilities.

The automated content propagation module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the automated content propagation module 102. For example, the data store 110 can store content posts, page association information, source page propagation criteria, destination page selection criteria, and the like. It is contemplated that there can be many variations or other possibilities.

The page clustering module 104 can be configured to group pages into a page cluster and/or identify a page cluster based on page association information. For example, a social networking system can maintain page association information that defines various relationships between pages on the social networking system. In one example, pages may be hierarchically related to one another, such as one or more parent pages that are associated with one or more child pages. In an example scenario, a parent page may be a page that is associated with a brand, while related child pages may be pages that are associated with individual locations (e.g., brick-and-mortar locations, electronic storefronts) of that brand.

The page clustering module 104 can be configured to group a plurality of pages together into a page cluster based on any page relationships that may be defined in page association information. As just one example, each store in a shopping center may have an associated page. Page association information can indicate the relationship between a set of pages associated with the stores of the shopping center, and the page clustering module 104 can group the set of pages together into a page cluster based on the page association information. In another example, if each page of a set of pages has the same administrator, the page association information can comprise information indicating that the set of pages can be grouped together into a page cluster based on those pages having the same administrator. In yet another example, if a set of pages is each associated with a particular category, location, and/or other shared characteristics (e.g., bakeries in Manhattan), those pages can be grouped together into a page cluster based on those shared characteristics. In another example, if pages in a set of pages are associated with one another based on a hierarchical relationship, such as a parent-child relationship, those pages can be grouped together into a page cluster. Many variations are possible.

Each page cluster identified by the page clustering module 104 can include at least one source page and at least one destination page. In certain embodiments, whether a page is a source page or a destination page may be a binary determination, such that each page can only be either a source page or a destination page. For example, in the example scenario of a page cluster comprising a parent page and one or more child pages, in various embodiments, the parent page can be a source page and the one or more child pages can each be destination pages. In other embodiments, a page can be both a source page and a destination page. Once again, in the example scenario of a page cluster comprising a parent page and one or more child pages, in various embodiments, the parent page can act as both a source page and a destination page. In such embodiments, the parent page can propagate content posts to child pages while also receiving content posts from child pages. Similarly, in various embodiments, a child page can act as both a source page and a destination page. For example, a child page can propagate content posts to a parent page or to other child pages. In one aspect of this example, child pages associated with brick-and-mortar locations within a particular geographic area (e.g., within Palo Alto, within San Mateo County, etc.) can be permitted to propagate content posts to one another. In various embodiments, it may be possible for a parent page and various child pages to propagate content to a target child page. For example, if the parent page and the various child pages are actively posting new content posts, but the target child page is inactive, content posts from the parent page and the various child pages can be propagated to the target child page. Many variations are possible.

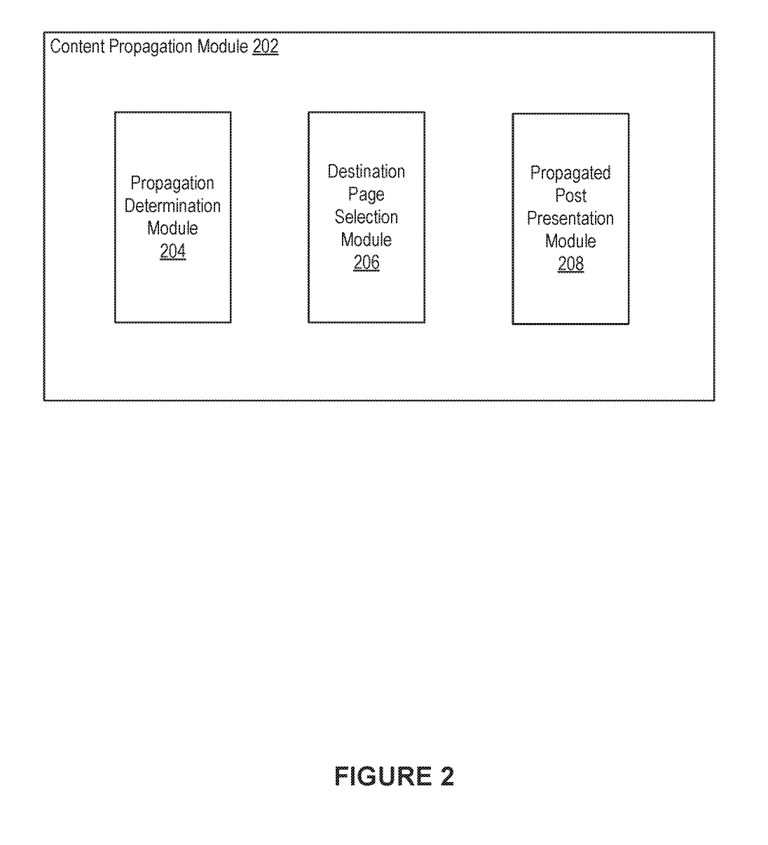

The content propagation module 106 can be configured to automatically propagate a content post from a first page in a page cluster to one or more other pages in the page cluster. In certain embodiments, each page cluster identified by the page clustering module 104 can include at least one source page and at least one destination page. The content propagation module 106 can be configured to select a content post from a source page of a page cluster and propagate it to at least one destination page in the page cluster. In some embodiments, propagation of the content post from the source page to the destination page causes the content post to be posted to the destination page. For example, consider an example scenario in which a set of pages are grouped into a page cluster based on a shared association with a national coffee shop chain. A first page of the page cluster can be associated with the brand of the national coffee shop chain, while a plurality of other pages in the page cluster can be associated with individual brick-and-mortar locations of the coffee shop chain. The first page associated with the brand itself can be identified as a source page, while the plurality of location-specific pages can be identified as destination pages. The administrator of the source page can post a content post to the source page, for example, announcing a new blended beverage. The content propagation module 106 can be configured to automatically and selectively propagate the content post to the plurality of destination pages. Propagation of the content post to the destination pages causes each destination page to also present the content post announcing the new blended beverage. In this way, the administrator of a source page can post a content post that will not only be posted to the source page, but will also automatically be posted to one or more destination pages. The content propagation module 106 is described in greater detail herein with reference to FIG. 2.

FIG. 2 illustrates an example content propagation module 202 configured to propagate a content post from a source page to at least one destination page, according to an embodiment of the present disclosure. In some embodiments, the content propagation module 106 of FIG. 1 can be implemented as the content propagation module 202. As shown in the example of FIG. 2, the content propagation module 202 can include a propagation determination module 204, a destination page selection module 206, and a propagated post presentation module 208.

The propagation determination module 204 can be configured to determine whether or not to propagate a content post posted to a source page. As mentioned above, each page cluster identified by the page clustering module 104 can include at least one source page. When a content post is posted to a source page, the propagation determination module 204 can be configured to make a propagation determination as to whether to propagate the content post to one or more destination pages. In certain embodiments, the propagation determination module 204 can be configured to automatically propagate every content post posted to a source page. In certain embodiments, the propagation determination module 204 can be configured to make a propagation determination based on source page propagation criteria.

Source page propagation criteria can include source page propagation settings which define one or more rules for propagation of content posts from a particular source page. For example, an administrator of the source page can select a propagation setting from a plurality of propagation settings. In this example, the plurality of propagation settings can include a first option to always propagate content posts. Further to this example, the plurality of propagation settings can include a second option to never propagate content posts. In relation to this example, the plurality of propagation settings can include a third option to propagate content posts only to particular or selected destination pages. In this regard, content posts can be propagated to destination pages that have never posted their own content posts, or to destination pages that have not posted a content post within a threshold period of time (e.g., within the past year), to name some examples. The propagation determination module 204 can make a propagation determination based on source page propagation settings selected by an administrator of a source page.

Source page propagation criteria can include content type criteria. For example, content type criteria can specify that particular types of content posts may be propagated to destination pages, while others may not. In the example of a source page that is associated with a nationwide coffee shop chain, content type criteria can specify that only content posts which include discount offers or coupons should be propagated to destination pages.

In another example, source page propagation criteria can include user engagement criteria. User engagement criteria can include, for example, a user engagement threshold. For example, the propagation determination module 204 can be configured to select for propagation only those content posts that satisfy the user engagement threshold, such as a minimum number of comments, shares, and/or likes from a source page or another destination page.

In certain embodiments, source page propagation criteria can include a post-specific selection by an administrator of the source page. The post-specific selection can be a selection option to propagate a particular content post or not to propagate the content post. For example, when an administrator of a source page posts a content post to the source page, the administrator may be provided with a binary option to either propagate the content post or not the propagate the content post. The propagation determination module 204 can be configured to propagate the content post or not propagate the content post based on the administrator's selection.

The destination page selection module 206 can be configured to determine one or more destination pages to which to propagate a content post based on destination page selection criteria. Once it is determined that a content post will be propagated, the destination page selection module 206 can be configured to determine one or more destination pages based on the destination page selection criteria. In certain embodiments, the destination page selection criteria can include destination page propagation settings. For example, an administrator of a destination page may be provided with the option to opt out of content post propagation. In other words, the administrator of a destination page may opt not to receive propagated content posts. The destination page selection module 206 can be configured not to propagate content posts to destination pages that have opted out of content post propagation.

In certain embodiments, destination page selection criteria can include content type criteria. The content type criteria can specify particular types of content posts that can be propagated to a particular destination page. For example, an administrator of a destination page may choose to accept only propagated content posts of a particular type. In such embodiments, the destination page selection module 206 can be configured to only propagate posts to a destination page that satisfy the content type criteria.

The destination page selection module 206 can be configured to, in response to receiving a content post from a source page for propagation, analyze each destination page associated with the source page, and determine whether or not to propagate the content post to the destination page based on the destination page selection criteria. The destination page selection module 206 can propagate the content post to any destination pages that satisfy the destination page selection criteria, while withholding the content post from any destination pages that do not satisfy the destination page selection criteria. For example, the destination page selection module 206 can poll each destination page of a page cluster to determine which destination pages have not opted out of content post propagation, and can propagate the content post to each such destination page.

The propagated post presentation module 208 can be configured to present on a destination page a content post that was propagated from a source page. When a content post is propagated to one or more destination pages, the propagated post presentation module 208 can be configured to present the content post on the one or more destination pages. The content post can be presented through, for example, a user interface that is displayed on a computing device of a user to whom the one or more destination pages are displayed.

In certain embodiments, the propagated post presentation module 208 can be configured to present content posts on a destination page in such a way that content posts that have been propagated from a source page can be distinguished from content posts that have been posted directly to the destination page. For example, a content post on a destination page can be presented with a page name associated with the content post. For propagated content posts, the page name can be a page name associated with a source page on which the content post was originally posted. Conversely, for content posts that are posted directly to a destination page (e.g., by an administrator of the destination page), the page name presented with the content post can be a page name associated with the destination page.

In certain embodiments, the propagated post presentation module 208 can be configured to present content posts with user engagement information. Users can engage with a content post by, for example, commenting on the content post, liking the content post, or sharing the content post. User engagement information for a content post can include, for example, a number of likes for the content post, a list of all users or a subset of users who have liked the content post, a number of comments on the content post, a list of all users or a subset of users who have commented on the content post, a list of all comments or a subset of comments on the content post, a number of users who have shared the content post, a list of all users or a subset of users who have shared the content post, and the like.

In certain embodiments, user engagement information presented with a content post may represent an aggregation of user engagement information across multiple instances of the content post across various pages. As noted above, a content post can be presented on a source page and can also be propagated and presented on one or more destination pages. Users can view and engage with the content post either via the source page, or via one of the one or more destination pages to which the content post has been propagated. In certain embodiments, content post engagement information for the content post can be aggregated for all instances of the content post across the source page and the various destination pages. For example, if twenty users like a content post via the source page, thirty users like the content post via a first destination page, and forty users like the content post via a second destination page, each of the source page, the first destination page, and the second destination page can indicate that the content post has been liked by 20+30+40=90 users.

In various embodiments, presentation of certain user engagement information for a content post may differ depending on whether a user is viewing the content post on a source page or a particular destination page. For example, if a user is viewing the content post on the source page, comments to the content post that were made via the source page may be upranked and presented above and/or before other comments that were posted to the content post via a destination page. Conversely, if a user is viewing the same content post on a particular destination page, comments that were made via the destination page may be upranked.

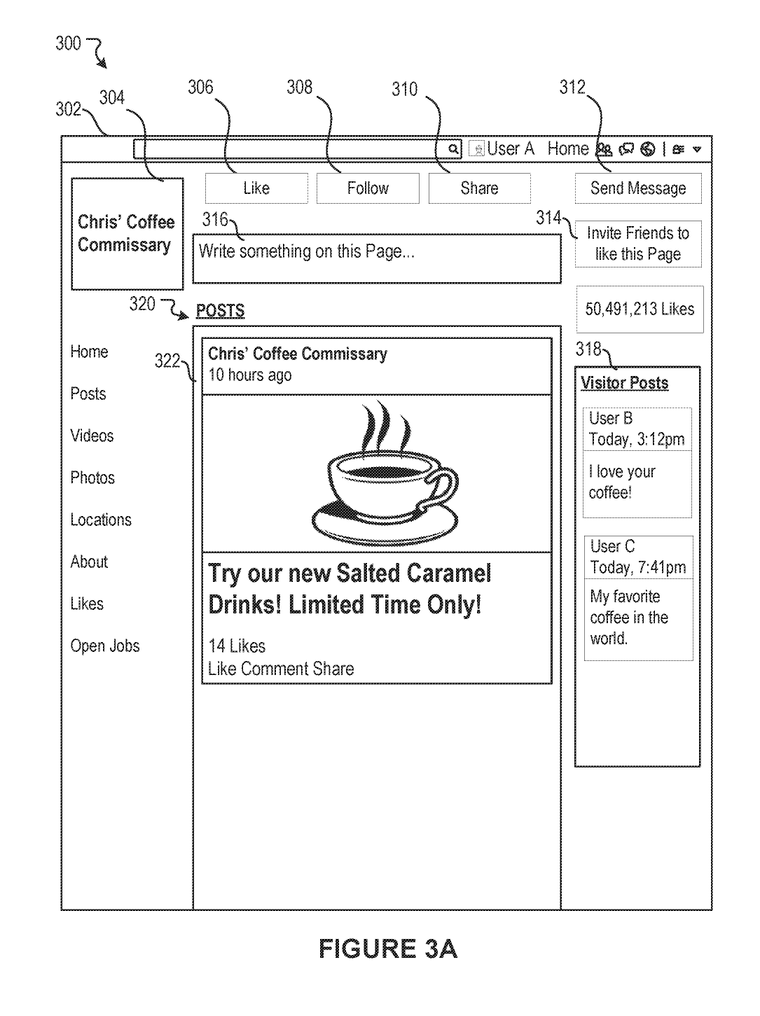

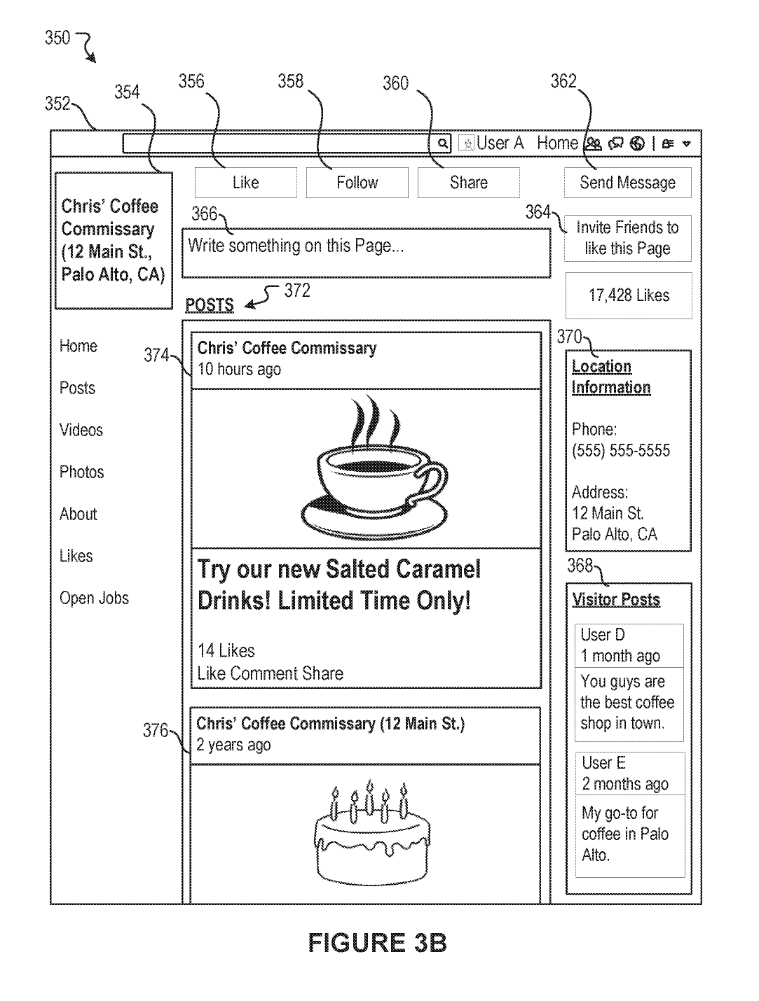

FIGS. 3A and 3B illustrate example scenarios 300, 350 associated with automated propagation of content posts, according to an embodiment of the present disclosure. FIG. 3A depicts the example scenario 300 including a user interface presenting a source page 302 on a social networking system. The source page 302 is associated with a nationwide coffee shop chain called “Chris' Coffee Commissary”, as indicated by a page name 304. The source page 302 is not associated with a particular location of the coffee shop chain, but rather, the brand itself. The source page 302 includes a like button 306 by which a user of the social networking system viewing the source page 302 can like the source page 302, a follow button 308 to allow users to follow the source page 302, a share button 310 to allow users to share the source page 302, a message button 312 to allow users to send a message to an administrator of the source page 302, and an invite friends button 314 to allow users to invite their friends on the social networking system to like the source page 302. The source page 302 includes a text entry block 316 through which a visitor of the source page 302 can write something to the source page 302. A subset of visitor posts can be presented in a visitor posts window 318.

The source page 302 includes a posts section 320, which includes a post 322. The post 322 is a post that has been posted directly to the source page 302 by an administrator of the source page 302. The post 322 invites customers to “Try our new Salted Caramel Drinks! Limited Time Only!”

FIG. 3B depicts the example scenario 350 including a user interface presenting a destination page 352 on the social networking system. The destination page 352 is associated with a particular location of Chris' Coffee Commissary, located at 12 Main St., Palo Alto, Calif., as indicated by a page name 354. The destination page 352 includes a like button 356, a follow button 358, a share button 360, a message button 362, an invite friends button 364, a text entry box 366, and a visitor posts window 368, similar to those that were described above with reference to the source page 302. The destination page 352 also includes a location information window 370 that includes phone number and address information for the particular location of Chris' Coffee Commissary associated with the destination page 352.

The social networking system can maintain page association information that indicates that the destination page 352 is a child page of the source page 302, and the source page 302 is a parent page of the destination page 352. As such, the destination page 352 is grouped into a page cluster with the source page 302, and content posts from the source page 302 can be propagated to the destination page 352.

It can be seen in FIG. 3B that the destination page 352 includes a posts section 372, and presents a content post 374 that is substantially identical to the content post 322 of the source page 302. The content post 374 has been automatically propagated from the source page 302 based on source page propagation criteria and destination page selection criteria. The destination page 352 also includes a second content post 376. The content post 374 is presented with a page name “Chris' Coffee Commissary,” whereas the content post 376 is presented with a page name “Chris' Coffee Commissary (12 Main St.).” The difference in page names indicates that the content post 374 was propagated from the source page 302, whereas the content post 376 was posted directly to the destination page 352 by an administrator of the destination page 352.

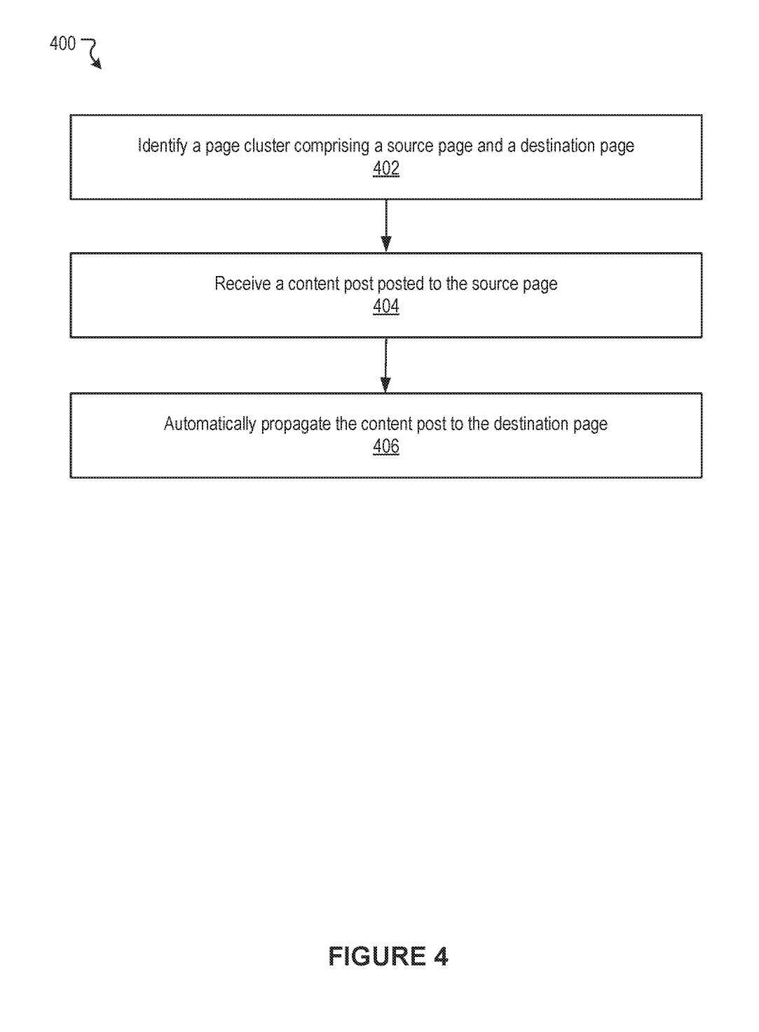

FIG. 4 illustrates an example method 400 associated with automated content post propagation, according to an embodiment of the present disclosure. It should be appreciated that there can be additional, fewer, or alternative steps performed in similar or alternative orders, or in parallel, within the scope of the various embodiments discussed herein unless otherwise stated.

At block 402, the example method 400 can identify a page cluster comprising a source page and a destination page. At block 404, the example method 400 can receive a content post posted to the source page. At block 406, the example method 400 can automatically propagate the content post to the destination page.

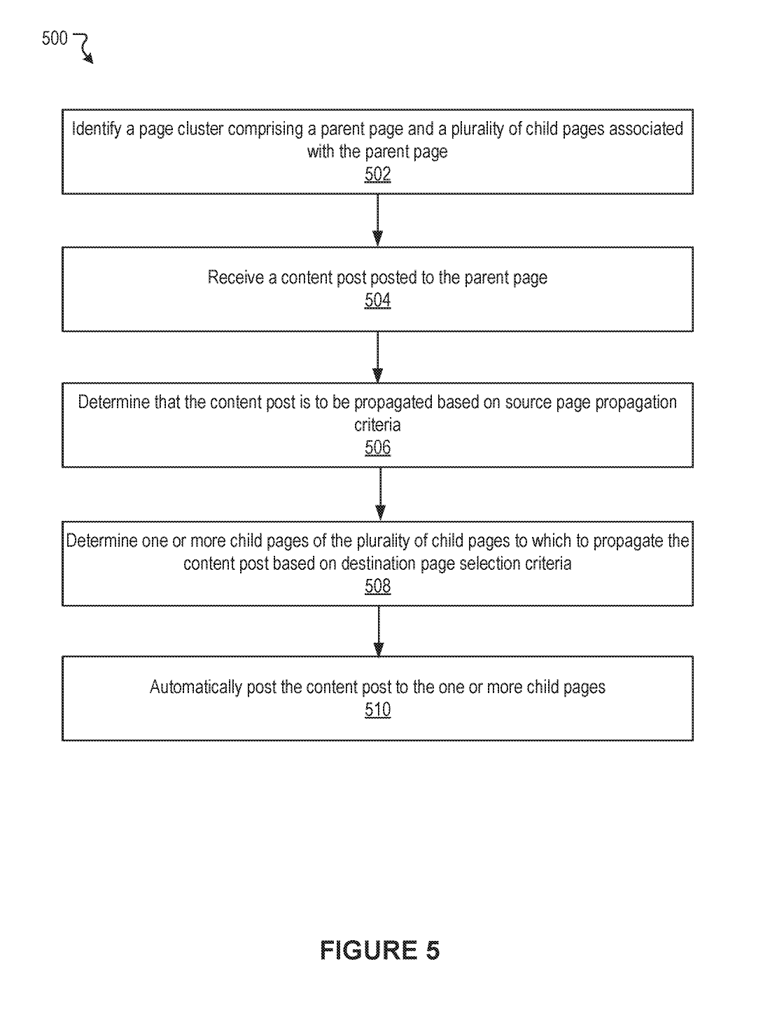

FIG. 5 illustrates an example method 500 associated with automated content post propagation, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can identify a page cluster comprising a parent page and a plurality of child pages associated with the parent page. At block 504, the example method 500 can receive a content post posted to the parent page. At block 506, the example method 500 can determine that the content post is to be propagated based on source page propagation criteria. At block 508, the example method 500 can determine one or more child pages of the plurality of child pages to which to propagate the content post based on destination page selection criteria. At block 510, the example method 500 can automatically post the content post to the one or more child pages.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an automated content propagation module 646. The automated content propagation module 646 can, for example, be implemented as the automated content propagation module 102, as discussed in more detail herein. As discussed previously, it should be appreciated that there can be many variations or other possibilities. For example, in some embodiments, one or more functionalities of the automated content propagation module 646 can be implemented in the user device 610.

### Hardware Implementation

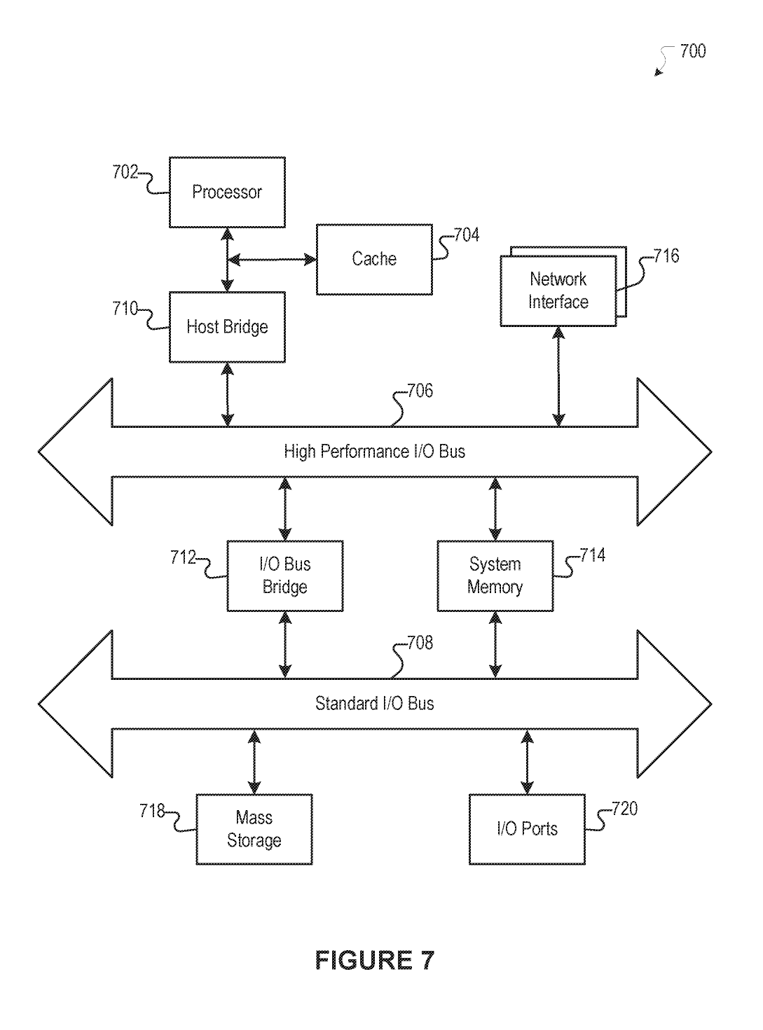

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
identifying, by a computing system, a page cluster comprising a source page and a destination page;
receiving, by the computing system, a content post posted to the source page; and
automatically propagating, by the computing system, the content post to the destination page.

2. The computer-implemented method of claim 1, wherein
the page cluster comprises a parent page and a plurality of child pages,
the source page is the parent page, and
the destination page is a child page of the plurality of child pages.

3. The computer-implemented method of claim 2, wherein
the parent page is associated with a brand, and
the child page is associated with a brick-and-mortar location of the brand.

4. The computer-implemented method of claim 1, further comprising determining that the content post is to be propagated based on source page propagation criteria.

5. The computer-implemented method of claim 4, wherein the source page propagation criteria comprises a propagation setting selected by an administrator of the source page.

6. The computer-implemented method of claim 5, wherein the propagation setting comprises at least one of: a selection to always propagate content posts, a selection to propagate content posts to destination pages that have never posted their own content posts, or a selection to propagate content posts to destination posts that have not posted their own content posts within a threshold period of time.

7. The computer-implemented method of claim 1, further comprising determining that the destination page has not opted out of content post propagation.

8. The computer-implemented method of claim 7, wherein the automatically propagating the content post to the destination page is performed based on the determining that the destination page has not opted out of content post propagation.

9. The computer-implemented method of claim 1, wherein
the automatically propagating the content post to the destination page causes the content post to be posted to the destination page, and
the content post is posted to the destination page with a page name that is associated with the source page.

10. The computer-implemented method of claim 1, wherein
the page cluster comprises a plurality of destination pages, and
the automatically propagating the content post to the destination page further comprises automatically propagating the content post to the plurality of destination pages.

11. A system comprising:
at least one processor; and
a memory storing instructions that, when executed by the at least one processor, cause the system to perform a method comprising:
identifying a page cluster comprising a source page and a destination page;
receiving a content post posted to the source page; and
automatically propagating the content post to the destination page.

12. The system of claim 11, wherein
the page cluster comprises a parent page and a plurality of child pages,
the source page is the parent page, and
the destination page is a child page of the plurality of child pages.

13. The system of claim 12, wherein
the parent page is associated with a brand, and
the child page is associated with a brick-and-mortar location of the brand.

14. The system of claim 11, wherein the method further comprises determining that the content post is to be propagated based on source page propagation criteria.

15. The system of claim 14, wherein the source page propagation criteria comprises a propagation setting selected by an administrator of the source page.

16. A non-transitory computer-readable storage medium including instructions that, when executed by at least one processor of a computing system, cause the computing system to perform a method comprising:
identifying a page cluster comprising a source page and a destination page;
receiving a content post posted to the source page; and
automatically propagating the content post to the destination page.

17. The non-transitory computer-readable storage medium of claim 16, wherein
the page cluster comprises a parent page and a plurality of child pages,
the source page is the parent page, and
the destination page is a child page of the plurality of child pages.

18. The non-transitory computer-readable storage medium of claim 17, wherein
the parent page is associated with a brand, and
the child page is associated with a brick-and-mortar location of the brand.

19. The non-transitory computer-readable storage medium of claim 16, wherein the method further comprises determining that the content post is to be propagated based on source page propagation criteria.

20. The non-transitory computer-readable storage medium of claim 19, wherein the source page propagation criteria comprises a propagation setting selected by an administrator of the source page.
